(19) United States
(12) Patent Application Publication
(10) Pub. No.: US 2026/0322194 A1
(43) Pub. Date: Oct. 15, 2026

(54) POWER TOOL MOTOR ROTOR CONFIGURATIONS

(71) Applicant: MILWAUKEE ELECTRIC TOOL CORPORATION, Brookfield, WI (US)

(72) Inventor: Ashad Farhan, Brookfield, WI (US)

(21) Appl. No.: 19/473,928

(22) PCT Filed: Apr. 18, 2024
(86) PCT No.: PCT/US2024/025129

§ 371 Date: Oct. 9, 2025

Related U.S. Application Data
(60) Provisional application No. 63/496,723, filed on Apr. 18, 2023.

(51) Int. Cl. H02K 1/276; B25F 5/00; H02K 1/02; H02K 7/14; H02K 9/06; H02K 21/16

(52) U.S. Cl. CPC H02K 1/2773; B25F 5/00; H02K 1/02; H02K 7/145; H02K 9/06; H02K 21/16; H02K 2213/03

(57) ABSTRACT

A Power tool may include a battery pack interface configured to receive a removable and rechargeable battery pack. A Power tool may include a motor including: a stator including a plurality of stator teeth configured to receive a plurality of stator coils, and a rotor including: a plurality of slots configured in a spoke-type configuration, each of the plurality of slots including a magnet housing portion configured to receive a magnet, wherein the magnet includes a length and a width, the length of the magnet being larger than half of a width of one of the plurality of stator teeth.

### RELATED APPLICATIONS

This application claims the benefit of U.S. Provisional Patent Application No. 63/496,723, filed Apr. 18, 2023, the entire content of which is hereby incorporated by reference.

### FIELD

Embodiments described herein relate to a motor of a power tool.

### SUMMARY

Power tools described herein include a battery pack interface configured to receive a removable and rechargeable battery pack, and a motor including: a stator including a plurality of stator teeth configured to receive a plurality of stator coils, and a rotor including: a plurality of slots configured in a spoke-type configuration, each of the plurality of slots including a magnet housing portion configured to receive a magnet. The magnet includes a length and a width, the length of the magnet being larger than half of a width of one of the plurality of stator teeth.

In some aspects, the motor has an outer diameter of between 43 millimeters and 55 millimeters.

In some aspects, the stator is a segmented stator.

In some aspects, the motor is a 9 slot, 6 pole motor.

In some aspects, the motor is a 9 slot, 8 pole motor.

In some aspects, the stator further includes a needle gap defined by a space between two adjacent stator coils of the plurality of stator coils.

In some aspects, the magnet is composed of neodymium iron boron, and the magnet is secured to the magnet housing portion using an adhesive.

In some aspects, the width of the magnet is determined by an equation:

Magnet Width=π(diameter of rotor−stator tooth width)/number of poles

In some aspects, the motor has a higher efficiency at lighter loads when compared to a motor with a higher number of slots and poles.

In some aspects, the motor has a higher peak output power value when compared to a motor with a lower number of slots and poles.

In some aspects, the motor has a peak output power value of approximately 1200 Watts at 0.90 N-m.

In some aspects, the motor has approximately an equal peak output power as an interior permanent magnet motor, and the motor has an outer diameter size of approximately 50% less than the interior permanent magnet motor.

In some aspects, the motor has an output power of approximately 13% greater when compared to an interior permanent magnet motor, and the motor includes an outer diameter size of approximately 25% less than the interior permanent magnet motor.

In some aspects, the motor has approximately a 28% increase in output power when compared to an interior permanent magnet motor, and the motor has approximately an equal outer diameter size as the interior permanent magnet motor.

In some aspects, the motor has approximately a 33% increase in output power when compared to an interior permanent magnet motor, and wherein the motor has an outer diameter size of approximately 21% larger than the interior permanent magnet motor.

Motors described herein include a stator including a plurality of stator teeth configured to receive a plurality of stator coils, and a rotor including: a plurality of slots configured in a spoke-type configuration, each of the plurality of slots including a magnet housing portion configured to receive a magnet, wherein the magnet includes a length and a width. The length of the magnet being larger than half of a width of one of the plurality of stator teeth.

In some aspects, the stator is a segmented stator.

In some aspects, the motor has an outer diameter of between 43 mm and 55 mm, and the motor has an output power of between 13% and 28% greater than an interior permanent magnet motor, the interior permanent magnet motor having an outer diameter of between 45 mm and 60 mm.

Power tools described herein include a battery pack interface configured to receive a removable and rechargeable battery pack, and a motor having an outer diameter of between 43 mm and 55 mm. The motor includes: a segmented stator including: a plurality of stator teeth configured to receive a plurality of stator coils, and a rotor including: a plurality of slots configured in a spoke-type configuration, each of the plurality of slots including a magnet housing portion configured to receive a magnet, wherein the magnet includes a length and a width. The length of the magnet being larger than half of a width of one of the plurality of stator teeth.

In some aspects, the motor has an output power of between 13% and 28% greater than an interior permanent magnet motor, the interior permanent magnet motor having an outer diameter of between 45 mm and 60 mm.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a side view of a power tool in accordance with some embodiments.

FIG. 2 illustrates a block diagram of a control system of the power tool of FIG. 1 in accordance with some embodiments.

FIG. 3 illustrates a battery pack for use with the power tool of FIG. 1 in accordance with some embodiments.

FIG. 4 illustrates a block diagram of a control system of the battery pack of FIG. 3 in accordance with some embodiments.

FIG. 5 illustrates a rotor including a spoke-type magnet configuration according to some embodiments.

FIG. 6 illustrates a rotor including a spoke-type magnet configuration according to some embodiments.

FIG. 7 illustrates a rotor including a spoke-type magnet configuration according to some embodiments.

FIG. 8 illustrates a rotor including a spoke-type magnet configuration according to some embodiments.

FIG. 9 illustrates a rotor including a spoke-type magnet configuration according to some embodiments.

FIG. 10 illustrates a rotor including a spoke-type magnet configuration according to some embodiments.

FIG. 11A-11B illustrates a rotor including a spoke-type magnet configuration according to some embodiments.

FIG. 12 illustrates a rotor including a spoke-type magnet configuration according to some embodiments.

FIGS. 13A and 13B illustrate a rotor including a spoke-type magnet configuration according to some embodiments.

FIG. 14A-14B illustrate a rotor including a spoke-type magnet configuration according to some embodiments.

FIG. 15 illustrates an expanded view of a motor rotor including a spoke-type magnet configuration according to some embodiments.

FIG. 16 illustrates an internal permanent magnet motor according to some embodiments.

FIG. 17 illustrates a motor including a rotor having a spoke-type magnet configuration according to some embodiments.

FIG. 18 illustrates a motor including a rotor having a spoke-type magnet configuration according to some embodiments.

FIG. 19 illustrates a motor including a rotor having a spoke-type magnet configuration according to some embodiments.

FIG. 20 is a graphical illustration of the performance of several motors according to some embodiments.

FIG. 21 is a graphical illustration of the performance of several motors according to some embodiments.

FIG. 22 is a graphical illustration of the performance of several motors according to some embodiments.

FIG. 23 is a graphical illustration of the performance of several motors according to some embodiments.

### DETAILED DESCRIPTION

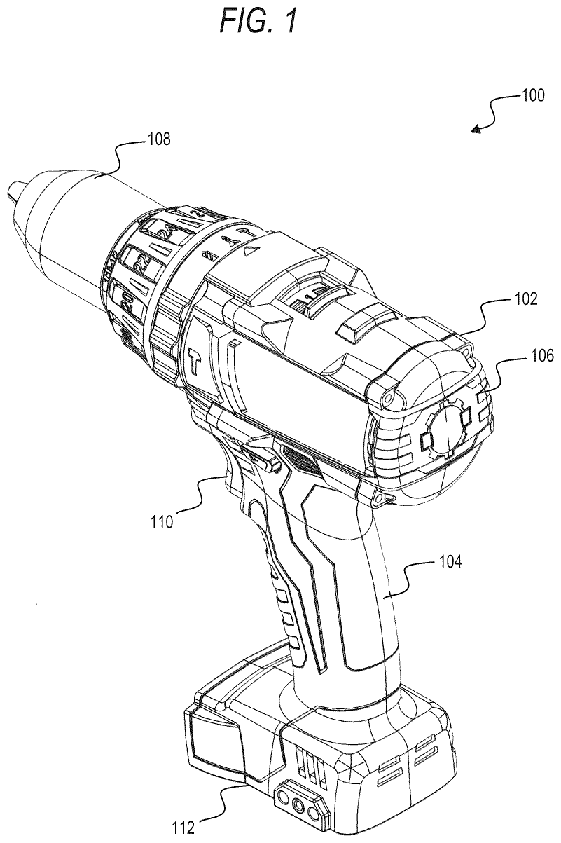

FIG. 1 illustrates a power tool 100 including a permanent magnet motor. The power tool 100 is, for example, a hammer drill including a housing 102. The housing 102 includes a handle portion 104 and motor housing portion 106. The power tool 100 further includes an output driver 108 (illustrated as a chuck), a trigger 110, and a battery pack interface 112. The battery pack interface 112 is configured to mechanically and electrically connect to or receive a removable, rechargeable power tool battery pack (also referred to as a battery pack). Although FIG. 1 illustrates a hammer drill, in some embodiments, the components described herein are incorporated into other types of power tools including drill-drivers, impact drivers, impact wrenches, angle grinders, circular saws, reciprocating saws, plate compactors, core drills, string trimmers, leaf blowers, vacuums, and the like. In a permanent magnet motor power tool, such as power tool 100, switching elements are selectively enabled and disabled by control signals from a controller to selectively apply power from a power source (e.g., battery pack) to drive a permanent magnet motor.

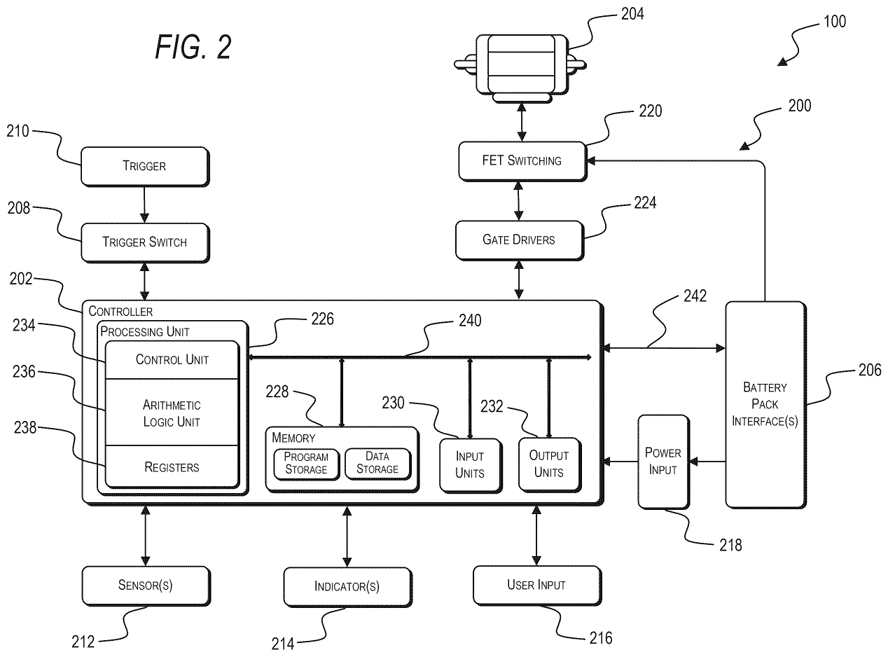

FIG. 2 illustrates a control system 200 for the power tool 100. The control system 200 includes a controller 202. The controller 202 is electrically and/or communicatively connected to a variety of modules or components of the power tool 100. For example, the illustrated controller 202 is electrically connected to a motor 204, a battery pack interface 206, a trigger switch 208 (connected to a trigger 210), one or more sensors 212 or sensing circuits, one or more indicators 214, a user input module 216, a power input module 218, an inverter bridge or FET switching module 220 (e.g., including a plurality of switching FETs), and gate drivers 224 for driving the FET switching module 220. In some embodiments, motor 204 is a permanent magnet motor. The controller 202 includes combinations of hardware and software that are operable to, among other things, control the operation of the power tool 100, monitor the operation of the power tool 100, activate the one or more indicators 214 (e.g., an LED), etc.

The controller 202 includes a plurality of electrical and electronic components that provide power, operational control, and protection to the components and modules within the controller 202 and/or the power tool 100. For example, the controller 202 includes, among other things, a processing unit 226 (e.g., a microprocessor, a microcontroller, an electronic controller, an electronic processor, or another suitable programmable device), a memory 228, input units 230, and output units 232. The processing unit 226 includes, among other things, a control unit 234, an arithmetic logic unit (“ALU”) 236, and a plurality of registers 238, and is implemented using a known computer architecture (e.g., a modified Harvard architecture, a von Neumann architecture, etc.). The processing unit 226, the memory 228, the input units 230, and the output units 232, as well as the various modules or circuits connected to the controller 202 are connected by one or more control and/or data buses (e.g., common bus 240). The control and/or data buses are shown generally in FIG. 2 for illustrative purposes. The use of one or more control and/or data buses for the interconnection between and communication among the various modules, circuits, and components would be known to a person skilled in the art in view of the invention described herein.

The memory 228 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 226 is connected to the memory 228 and executes software instructions that are capable of being stored in a RAM of the memory 228 (e.g., during execution), a ROM of the memory 228 (e.g., on a generally permanent basis), or another non-transitory computer readable medium such as another memory or a disc. Software included in the implementation of the power tool 100 can be stored in the memory 228 of the controller 202. The software includes, for example, firmware, one or more applications, program data, filters, rules, one or more program modules, and other executable instructions. The controller 202 is configured to retrieve from the memory 228 and execute, among other things, instructions related to the control processes and methods described herein. In other constructions, the controller 202 includes additional, fewer, or different components.

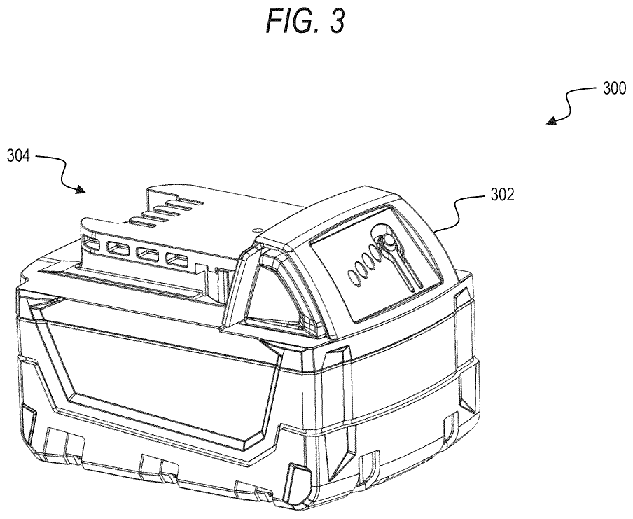

The battery pack interface 206 includes a combination of mechanical components (e.g., rails, grooves, latches, etc.) and electrical components (e.g., one or more terminals) configured to and operable for interfacing (e.g., mechanically, electrically, and communicatively connecting) with a battery pack. For example, power provided by a battery pack 300 (see FIG. 3) to the power tool 100 is provided through the battery pack interface 206 to the power input module 218. The power input module 218 includes combinations of active and passive components to regulate or control the power received from the battery pack 300 prior to power being provided to the controller 202. The battery pack interface 206 also supplies power to the FET switching module 220 to be switched by the switching FETs to selectively provide power to the motor 204. The battery pack interface 206 also includes, for example, a communication line 242 for providing a communication line or link between the controller 202 and the battery pack 300.

The sensors 212 include one or more current sensors, one or more speed sensors, one or more Hall effect sensors, one or more temperature sensors, etc. The indicators 214 include, for example, one or more light-emitting diodes (“LEDs”). The indicators 214 can be configured to display conditions of, or information associated with, the power tool 100. For example, the indicators 214 are configured to indicate measured electrical characteristics of the power tool 100, the status of the power tool, the status the motor 204, etc. The user input module 216 is operably coupled to the controller 202 to, for example, select a forward mode of operation or a reverse mode of operation, a torque and/or speed setting for the power tool 100 (e.g., using torque and/or speed switches), etc. In some embodiments, the user input module 216 includes a combination of digital and analog input or output devices required to achieve a desired level of operation for the power tool 100, such as one or more knobs, one or more dials, one or more switches, one or more buttons, etc.

FIG. 3 illustrates a battery pack 300. The battery pack 300 includes a housing 302 and an interface portion 304 for connecting the battery pack 300 to a power tool, such as the power tool 100.

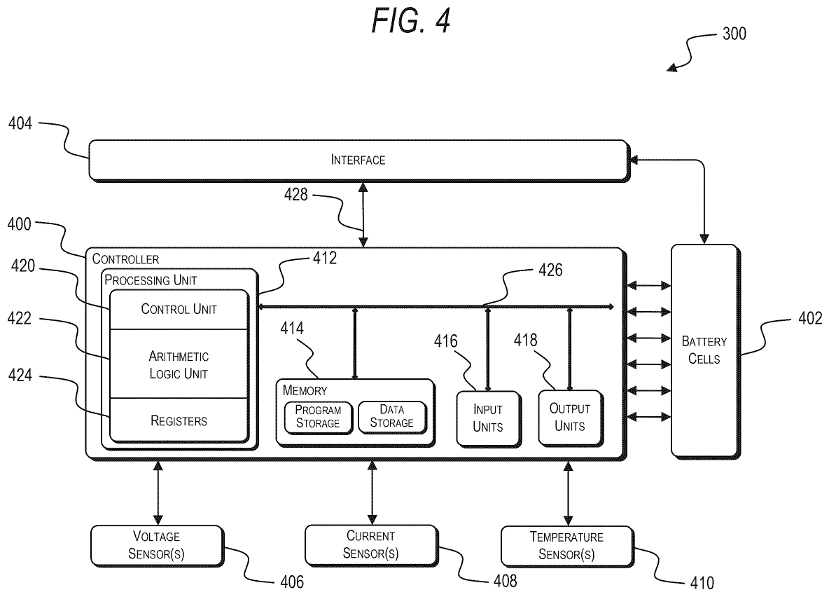

FIG. 4 illustrates a control system for the battery pack 300. The control system includes a controller 400. The controller 400 is electrically and/or communicatively connected to a variety of modules or components of the battery pack 300. For example, the illustrated controller 400 is connected to one or more battery cells 402 and an interface 404 (e.g., the interface portion 304 of the battery pack 300 illustrated in FIG. 3). The controller 400 is also connected to one or more voltage sensors or voltage sensing circuits 406, one or more current sensors or current sensing circuits 408, and one or more temperature sensors or temperature sensing circuits 410. The controller 400 includes combinations of hardware and software that are operable to, among other things, control the operation of the battery pack 300, monitor a condition of the battery pack 300, enable or disable charging of the battery pack 300, enable or disable discharging of the battery pack 300, etc.

The controller 400 includes a plurality of electrical and electronic components that provide power, operational control, and protection to the components and modules within the controller 400 and/or the battery pack 300. For example, the controller 400 includes, among other things, a processing unit 412 (e.g., a microprocessor, a microcontroller, an electronic processor, an electronic controller, or another suitable programmable device), a memory 414, input units 416, and output units 418. The processing unit 412 includes, among other things, a control unit 420, an ALU 422, and a plurality of registers 424, and is implemented using a known computer architecture (e.g., a modified Harvard architecture, a von Neumann architecture, etc.). The processing unit 412, the memory 414, the input units 416, and the output units 418, as well as the various modules or circuits connected to the controller 400 are connected by one or more control and/or data buses (e.g., common bus 426). The control and/or data buses are shown generally in FIG. 4 for illustrative purposes. The use of one or more control and/or data buses for the interconnection between and communication among the various modules, circuits, and components would be known to a person skilled in the art in view of the invention described herein.

The memory 414 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 412 is connected to the memory 414 and executes software instructions that are capable of being stored in a RAM of the memory 414 (e.g., during execution), a ROM of the memory 414 (e.g., on a generally permanent basis), or another non-transitory computer readable medium such as another memory or a disc. Software included in the implementation of the battery pack 300 can be stored in the memory 414 of the controller 400. The software includes, for example, firmware, one or more applications, program data, filters, rules, one or more program modules, and other executable instructions. The controller 400 is configured to retrieve from the memory 414 and execute, among other things, instructions related to the control processes and methods described herein. In other constructions, the controller 400 includes additional, fewer, or different components.

The interface 404 includes a combination of mechanical components (e.g., rails, grooves, latches, etc.) and electrical components (e.g., one or more terminals) configured to and operable for interfacing (e.g., mechanically, electrically, and communicatively connecting) the battery pack 300 with another device (e.g., a power tool, a battery pack charger, etc.). For example, the interface 404 is configured to communicatively connect to the controller 400 via a communications line 428.

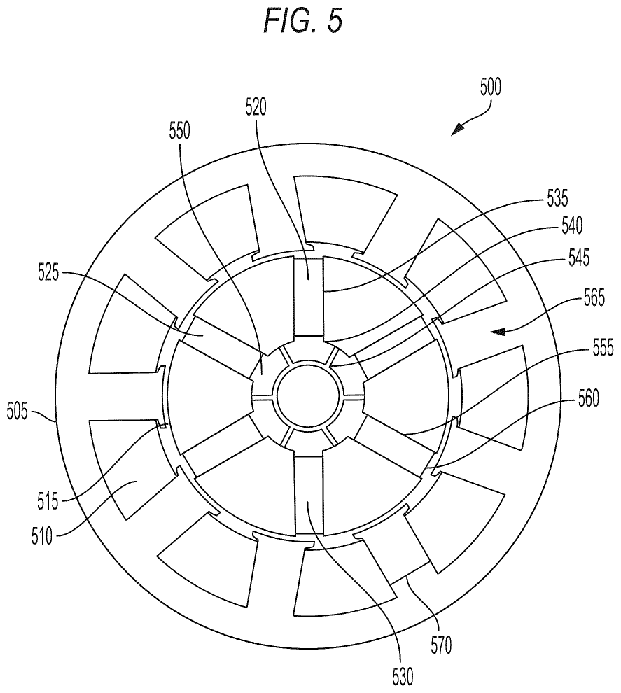

FIG. 5 illustrates a motor 500 for use in the power tool 100. The motor 500 includes a spoke-type magnet configuration. The motor 500 includes a stator 505 and a plurality of stator winding slots 510. The plurality of stator winding slots 510 are configured to receive a plurality of windings (also referred to as stator coils). The motor 500 also includes a rotor 515. The rotor 515 includes a plurality of slots 520 configured in a spoke-type configuration, and each of the plurality of slots 520 includes a magnet housing portion 525 configured to receive a magnet 530. The magnet may be made of neodymium, ferrite, neodymium iron boron, or another type of magnetic material. In some examples, the magnet 530 may be fixed within the magnet housing portion 525 using injection molding, adhesives, or another method of securely seating the magnets. The magnet housing portion 525 includes a first portion 535 spaced a first radial distance from the center of rotation of the rotor, and a second portion 540 spaced a second radial distance from the center of rotation of the rotor. In the illustrated embodiment, the second portion 540 includes inner ribs 545 configured to connect the magnet housing portions to each other via a central barrier. Between the inner ribs 545 is an air gap 550. The magnet housing portions 525 are configured to receive the magnets 530. The magnets 530 including a length 555 and a width 560.

In some examples, the length 555 of the magnet 530 is larger than half of a width 565 of a stator tooth 570 (also referred to as stator teeth). In some examples, the width 560 of the magnet 530 is determined based upon the following equation:

$$Magnet Width = \frac{π ( diameter of rotor - stator tooth width )}{number of poles} \qquad EQN . 1$$

For example, a motor may include a rotor diameter of 40 millimeters, a stator tooth width of 8 millimeters, and have 6 poles. In this example, the maximum width of the magnet is approximately 16.7 millimeters.

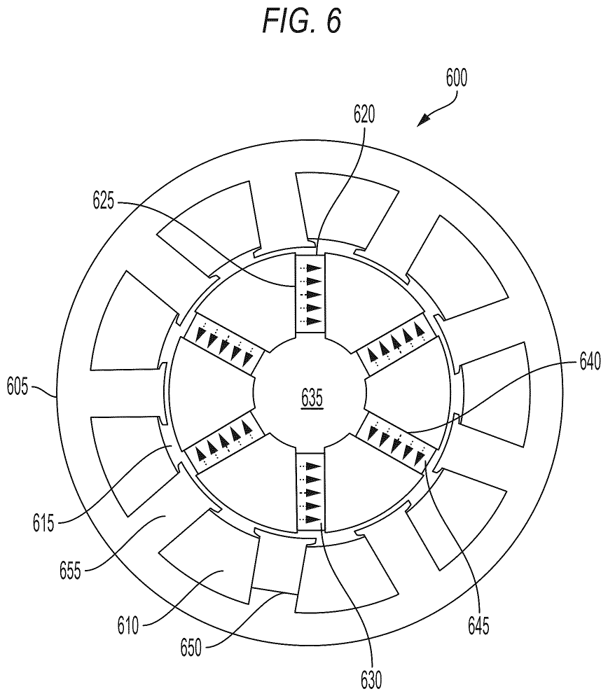

FIG. 6 illustrates a motor 600 for use in the power tool 100. The motor 600 includes a spoke-type magnet configuration. The motor 600 includes a stator 605 and a plurality of stator winding slots 610. The plurality of stator winding slots 610 are configured to receive a plurality of windings. The motor 600 also includes a rotor 615. The rotor 615 includes a plurality of slots 620 configured in a spoke-type configuration, and each of the plurality of slots 620 includes a magnet housing portion 625 configured to receive a magnet 630. The magnet 630 may be composed of similar materials as previously described, and/or secured to the magnet housing portion 625 as previously described. In the illustrated embodiment, the rotor 615 includes an open central rotor 635 that would receive a motor shaft. The open central rotor 635 advantageously improves the overall electromagnetic performance of the motor 600 by approximately 5%. The magnet housing portions are configured to receive the magnets 630, the magnets including a length 640 and a width 645. In some examples, the length 640 of the magnet 630 must be larger than half of a width 650 of a stator tooth 655. In some examples, the width 645 of the magnet 630 may be determined by EQN. 1 as described above.

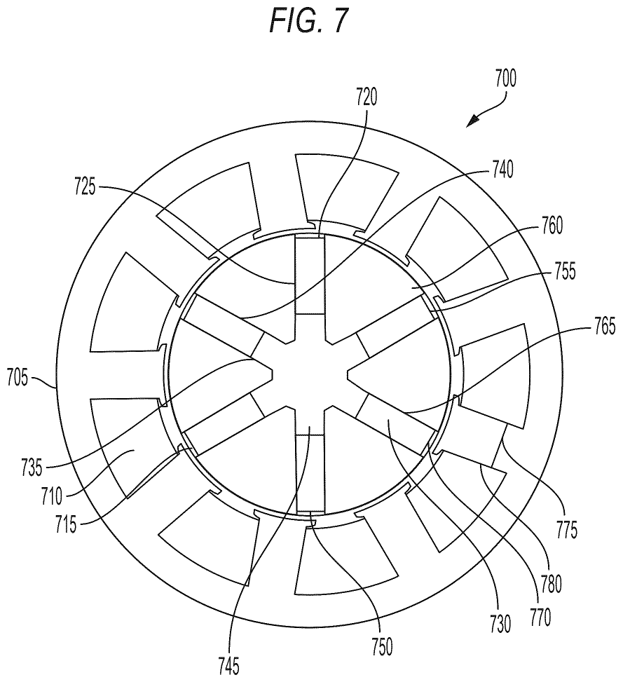

FIG. 7 illustrates a motor 700 for use in the power tool 100. The motor 700 includes a spoke-type magnet configuration. The motor 700 includes a stator 705 and a plurality of stator winding slots 710. The plurality of stator winding slots 710 are configured to receive a plurality of windings. The motor 700 also includes a rotor 715. The rotor 715 includes a plurality of slots 720 configured in a spoke-type configuration, and each slot includes a magnet housing portion 725 configured to receive a magnet 730. The magnet 730 may be composed of similar materials as previously described, and/or secured to the magnet housing portion 725 as previously described. The magnet housing portion includes a first portion 735 spaced a first radial distance from the center of rotation of the rotor 715, and a second portion 740 spaced a second radial distance from the center of rotation of the rotor 715. In the illustrated embodiment, the second portion 740 includes an open central rotor 745 and an outer rib 750 for each magnet housing portion 725. The outer rib 750 is positioned to close the plurality of slots 720. The outer rib includes a length 755 and a width 760. For example, the width 760 of the outer rib may be between 0.1 millimeters and 1.4 millimeters. The magnet housing portions are configured to receive the magnets, the magnets including a length 765 and a width 770. In some examples, the length 765 of the magnet 730 must be larger than half of a width 775 of a stator tooth 780. In some examples, the width 775 of the magnet 730 may be determined by EQN. 1 as described above.

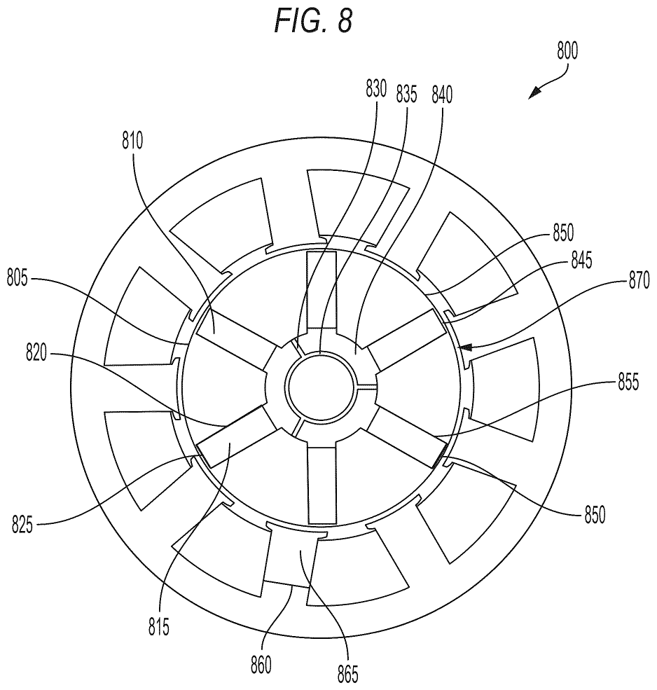

FIG. 8 illustrates a motor 800 including rotor 805 for use in the power tool 100. The rotor 805 includes a spoke-type magnet configuration. The rotor 805 includes a plurality of slots configured in a spoke-type configuration, and each slot includes a magnet housing portion 810. The magnet housing portions 810 are each configured to receive a magnet 815. The magnet 815 may be composed of similar materials as previously described, and/or secured to the magnet housing portion 810 as previously described. The magnet 815 include a length 820 and a width 825. In some examples, the length 820 of the magnet 815 must be larger than half of a width 860 of a stator tooth 865. In some examples, the width 825 of the magnet 815 may be determined by EQN. 1 as described above.

In the illustrated embodiment, the rotor 805 includes inner ribs 830 configured to connect the magnet housing portions 810 to each other via a central barrier 835 (e.g., a central ring or arcuate portion of the rotor 805). The inner ribs 830 are alternatively spaced between every other of the plurality of slots. Positioned between the inner ribs 830 is a flux barrier, or airspace barrier 840. In some instances, there are a plurality of inner ribs and a plurality of airspace barriers, and at least one of the plurality of air space barriers is between a corresponding one of the plurality of inner ribs. The magnet housing portions 810 are exposed to the airspace barrier 840 on an inner portion of the rotor 805, and the magnet housing portions 810 include an outer rib 845 positioned at an outer portion 850 of the rotor 805. The outer rib 845 includes a length 855 and a width 860. For example, the width of the outer rib 845 may be between 0.1 millimeters and 1.4 millimeters. In some embodiments, the outer ribs 845 each include a concave portion 870 formed on an outer circumference of the rotor 805.

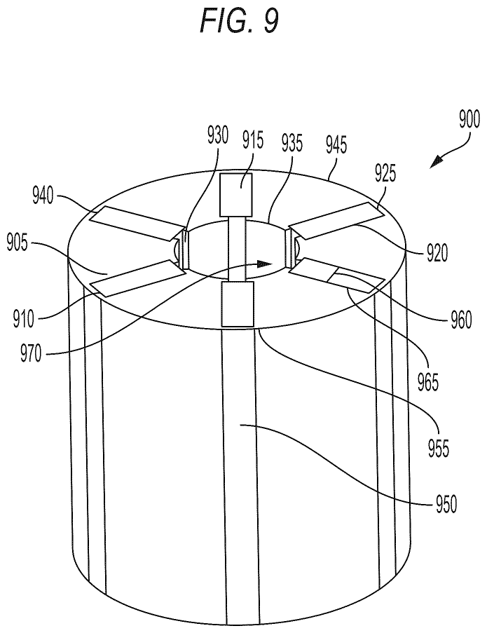

FIG. 9 illustrates a motor rotor 900 including a spoke-type magnet configuration. The rotor 900 includes a plurality of slots 905 configured in a spoke-type configuration, and each slot 905 includes a magnet housing portion 910 configured to receive a magnet 915. The magnet 915 may be composed of similar materials as previously described, and/or secured to the magnet housing portion 910 as previously described. The magnets 915 include a length 920 and a width 925. In some examples, the length 920 of the magnet 915 must be larger than half of a width 960 of a stator tooth 965. In some examples, the width 925 of the magnet 915 may be determined by EQN. 1 as described above.

In some embodiments, the magnet housing portions 910 include a magnet holding portions 930, also referred to as a shoe, positioned on an inner circumference 935 of the magnet housing portions 910. The shoe is configured to assist the magnet housing portion 910 in securely housing the magnet 915. In some instances, the shoe thickness is greater than 0.2 mm, and the space between the each of the shoes is greater than 0.2 mm. Additionally, in some embodiments, the magnet housing portion 910 includes an outer rib 940. The outer rib 940 is positioned on an outer circumference 945 of the magnet housing portion 910. The outer rib 940 includes a length 950 and a width 955. For example, the width of the outer rib 940 may be between 0.1 millimeters and 1.4 millimeters. In some embodiments, the rotor 900 includes an open central rotor 970, similar to the open central rotor 635 as previously described and illustrated in FIG. 6.

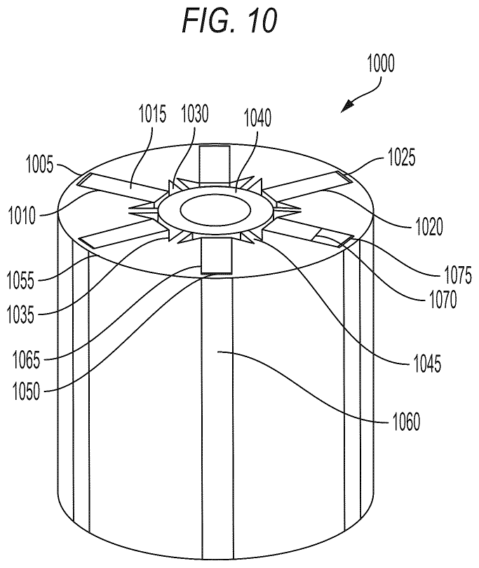

FIG. 10 illustrates a rotor 1000 for use with the power tool 100. The rotor 1000 includes a spoke-type magnet configuration. The rotor 1000 includes a plurality of slots 1005 configured in a spoke-type configuration, and each slot 1005 includes a magnet housing portion 1010 configured to receive a magnet 1015. The magnet 1015 may be composed of similar materials as previously described, and/or secured to the magnet housing portion 1010 as previously described. The magnets 1015 include a length 1020 and a width 1025. In some examples, the length 1020 of the magnet 1015 must be larger than half of a width 1070 of a stator tooth 1075. In some examples, the width 1025 of the magnet 1015 may be determined by the equation as described above. In some embodiments, the magnet housing portion 1010 includes an air gap 1030 positioned on an inner circumference 1035 of the magnet housing portion 1010. The air gap 1030 separates the magnet housing portion from a central circumference 1040 of the rotor 1000. The air gaps 1030 includes inner ribs 1045 positioned between two of the magnet housing portions 1010. Additionally, in some embodiments, the magnet housing portion 1010 includes an outer rib 1050. The outer rib 1050 is positioned on an outer circumference 1055 of the magnet housing portion 1010. The outer rib 1050 includes a length 1060 and a width 1065. For example, the width of the outer rib 1050 may be between 0.1 millimeters and 1.4 millimeters. In some examples, the width 1025 of the magnet 1015 may be determined by EQN. 1 as described above.

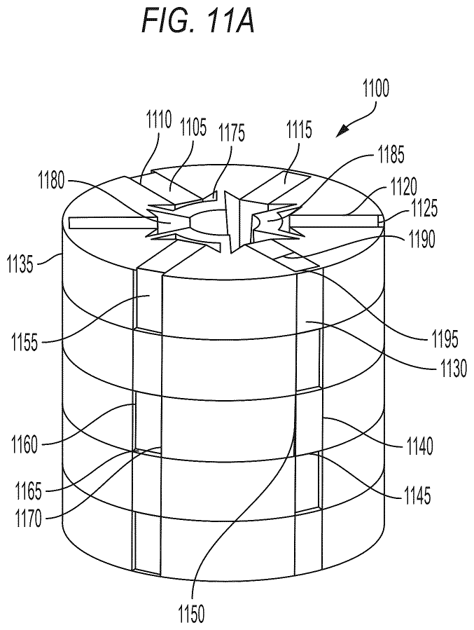

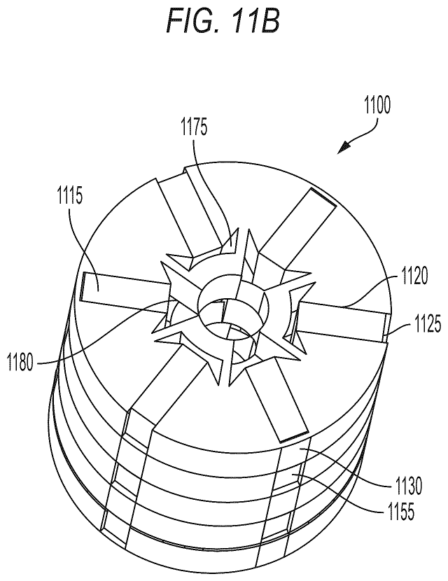

FIGS. 11A and 11B illustrate a rotor 1100 for use with the power tool 100. In some instances, the rotor 1100 as configured in FIGS. 11A and 11B has a reduced flux leakage as compared to alternative motor configurations, such as the rotor 1000 previously illustrated in and described with respect to FIG. 10. The rotor 1100 includes a spoke-type magnet configuration. The rotor 1100 includes a plurality of slots 1105 configured in a spoke-type configuration, and each slot includes a magnet housing portion 1110 configured to receive a magnet 1115. The magnet 1115 may be composed of similar materials as previously described, and/or secured to the magnet housing portion 1110 as previously described. The magnets 1115 include a length 1120 and a width 1125. In some examples, the length 1120 of the magnet 1115 must be larger than half of a width 1190 of a stator tooth 1195. In some examples, the width 1125 of the magnet 1115 may be determined by the equation as described above. In some embodiments, the rotor 1100 includes a plurality of alternating outer rib portions 1130 positioned on an outer circumference 1135 of the magnet housing portion 1110. The plurality of alternating outer rib portions 1130 includes a length 1140 and a width 1145. In some instances, the width 1145 of the outer rib portions 1130 spans a range of between 0.1 millimeters and 1.4 millimeters. The length extends a first longitudinal distance 1150 in an axial direction of the rotor 1100. Additionally, the magnet housing portions 1110 include a plurality of outer air gaps 1155 spaced between each of the plurality of alternating outer rib portions 1130, such that the space between each of the plurality of alternating outer rib portions 1130 includes a length 1160 and a width 1165, the length 1160 extending a second longitudinal distance 1170 in the axial direction of the rotor 1100. In some examples, the outer air gaps 1155 include a length and a width approximately equal to the length 1160 and width 1165 of each of the plurality of alternating outer rib portions 1130. In some examples, the width 1125 of the magnet 1115 may be determined by EQN. 1 as described above.

In some embodiments, the magnet housing portion includes a plurality of inner air gap portions 1175 positioned on an inner circumference 1180 of the magnet housing portion 1110. The plurality of inner air gap portions 1175 separates the magnet housing portion 1110 from a central circumference 1185 of the rotor 1100. In some embodiments, the plurality of inner air gap portions 1175 are spaced in an opposite configuration to the plurality of outer rib portions 1130. For example, for the first longitudinal distance 1150, the magnet housing portion 1110 includes an outer rib portion 1130 but does not include an inner air gap portion 1175, and for the second longitudinal distance 1170, the magnet housing portion 1110 includes an inner air gap portion 1175, but does not include an outer rib portion 1130.

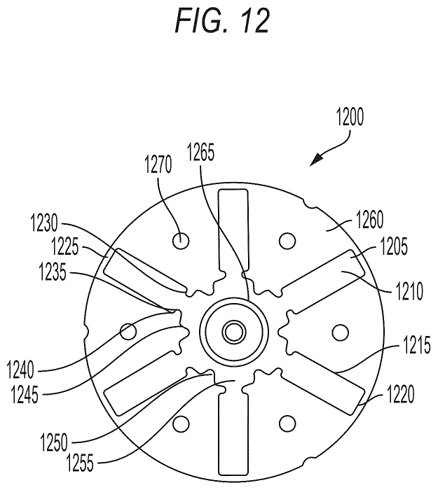

FIG. 12 illustrates a rotor 1200 for use in the power tool 100. The rotor 1200 includes a spoke-type magnet configuration. The rotor 1200 includes a plurality of slots 1205 configured in a spoke-type configuration, and each slot 1205 includes a magnet housing portion 1210 configured to receive a magnet. The magnet may be composed of similar materials as previously described, and/or secured to the magnet housing portion 1210 as previously described. The magnet housing portion 1210 includes a length 1215 and a width 1220. In some embodiments, the magnet housing portions 1210 include an outer rib portion 1225, as similarly previously described, and the outer rib portion may span a range of between 0.1 millimeters and 1.4 millimeters. The magnet housing portions 1210 also include an inner shoe portion 1230 configured to securely retain the magnet. The inner shoe portion 1230 includes a first length 1235 and a first width 1240 on each side of the inner shoe portion 1230. In some embodiments, the inner shoe portion 1230 includes a convex portion 1245 and a concave portion 1250. In some embodiments, the magnet housing portion 1210 includes a plurality of inner shoe portions. For example, in some instances, the magnet housing portion 1210 includes two inner shoe portions, where each of the inner shoe portions are configured on opposite sides of the magnet housing portion, and where each of the two inner shoe portions are configured to retain the magnet within the magnet housing portion 1210.

In some embodiments, the rotor 1200 includes an overmolding shaft 1255 on an inside circumference of the rotor 1200. The overmolding may be, for example, a material injected between a lamination stack portion 1260 of the rotor 1200 and a shaft portion 1265 of the rotor 1200. For instance, the material may be one selected from a group consisting of injection molding plastic, an epoxy resin, Polyurethane, silicon steel, a composite material, a thermal interface material, or the like. The lamination stack portion 1260 includes gaps 1270 formed between adjacent magnet housing portions 1210. In some embodiments, gaps 1270 are also filled with injected material. In some examples, the width 1220 of a magnet for the magnet housing portions 1210 may be determined by EQN. 1 as described above.

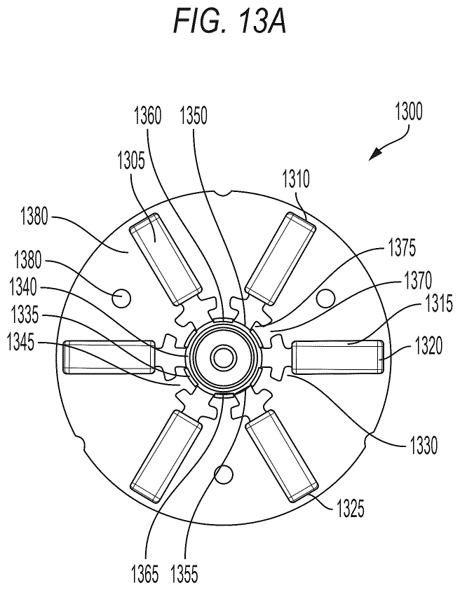

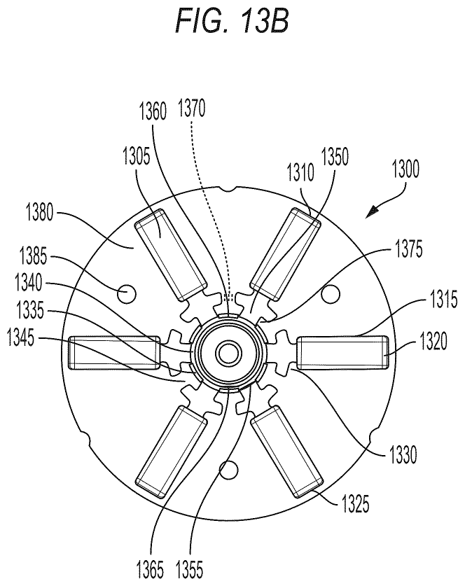

FIGS. 13A and 13B illustrate a rotor 1300 for use in the power tool 100. The rotor 1300 includes a spoke-type magnet configuration. The rotor 1300 includes a plurality of slots 1305 configured in a spoke-type configuration, and each slot 1305 includes a magnet housing portion 1310 configured to receive a magnet. The magnet may be composed of similar materials as previously described, and/or secured to the magnet housing portion 1310 as previously described. The magnet housing portion 1310 includes a length 1315 and a width 1320. In some embodiments, the magnet housing portions 1310 include an outer rib portion 1325 and an inner shoe 1330, and an inner rib 1375 as similarly previously described. In some examples, the rotor 1300 includes a minimum interference fit 1335 between an outer circumference 1340 of the shaft and an inner circumference 1345 of the lamination stack. For example, in some embodiments, the minimum interference fit 1335 may be no larger than 10 microns. In some embodiments, the surface of the shaft includes a knurled portion 1350 that extends a first circumferential distance 1355 around the shaft and a smooth portion 1360 that extends a second circumferential distance 1365 around the shaft. In some examples, the rotor 1300 includes a crumple zone 1370 positioned on an inner portion of rotor 1300, as shown in FIG. 13B. In some instances, the crumple zone may be configured to compress, or deform, the inner rib 1375 during press fitting of the shaft. A lamination stack portion 1380 includes gaps 1385. In some examples, the width 1320 of a magnet for the magnet housing portions 1310 may be determined by EQN. 1 as described above.

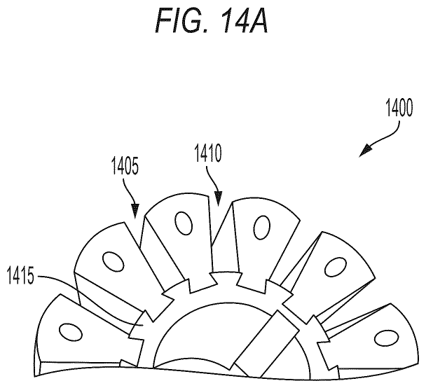

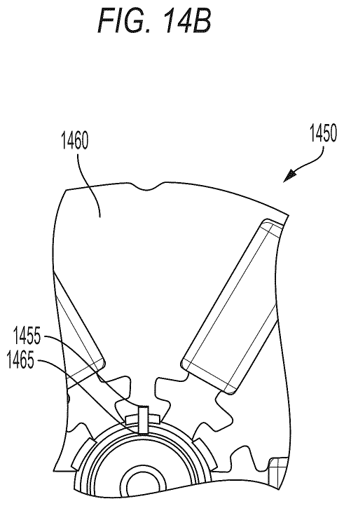

FIG. 14A illustrates a rotor 1400 for use with the power tool 100. The rotor 1400 includes a spoke-type magnet configuration. The rotor 1400 includes a plurality of slots 1405 configured in a spoke-type configuration, and each slot 1405 includes a magnet housing portion 1410 configured to receive a magnet. The magnet may be composed of similar materials as previously described, and/or secured to the magnet housing portion 1410 as previously described. The plurality of slots 1405 and the magnet housing portions 1410 are similar to previously described slots and magnet housing portions. In some embodiments, the rotor includes a stainless-steel ring portion 1415 on an interior of the rotor 1400. In some examples, a width of a magnet for the magnet housing portions 1410 may be determined by EQN. 1 as described above.

FIG. 14B illustrates a rotor 1450 for use with the power tool 100. The rotor 1450 includes a first key groove 1455 positioned on a portion of a lamination stack 1460 of the rotor 1450, and a second key groove 1465 positioned on a portion of the shaft. In some embodiments, the first key groove 1455 and the second key groove 1465 reduce, eliminate, or prevent slipping of the lamination stack 1460.

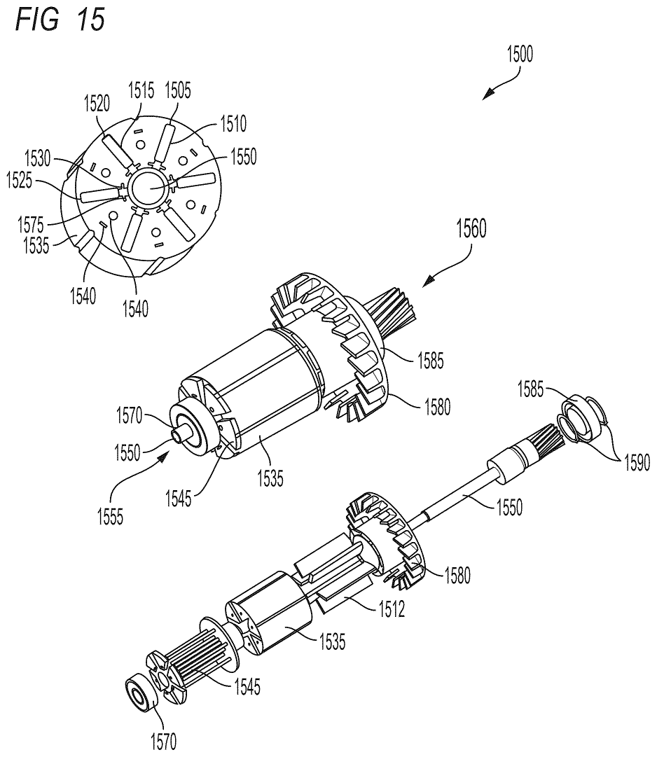

FIG. 15 illustrates a rotor 1500 for use with the power tool 100. The rotor 1500 includes a plurality of slots 1505 configured in a spoke-type configuration, and each slot 1505 includes a magnet housing portion 1510 configured to receive a magnet 1512. The magnet 1512 may be composed of similar materials as previously described, and/or secured to the magnet housing portion 1510 as previously described. The magnet housing portion 1510 includes a length 1515 and a width 1520. In some embodiments, the magnet housing portions 1510 include an outer rib portion 1525, an inner shoe 1530, and an inner rib 1575, as similarly previously described. The rotor includes a lamination stack 1535 including a plurality of gaps 1540. In some instances, the gaps 1540 are filled with an injection molded material, such as injection molded plastic 1545. The rotor 1500 also includes a shaft 1550 extending through the rotor 1500 from a first end 1555 of the rotor 1500 to a second end 1560 of the rotor 1500. Located at the first end 1555 of the rotor 1500 is a first bearing 1570. The rotor 1500 also includes a fan 1580 located at the second end of the rotor 1500. The rotor further includes a second bearing 1585 located at the second end 1560 of the rotor, and a plurality of C-rings 1590 configured to couple the second bearing 1585 to the rotor 1500 shaft 1550. In some embodiments, the shaft 1550 is includes a knurled surface for injection molding purposes.

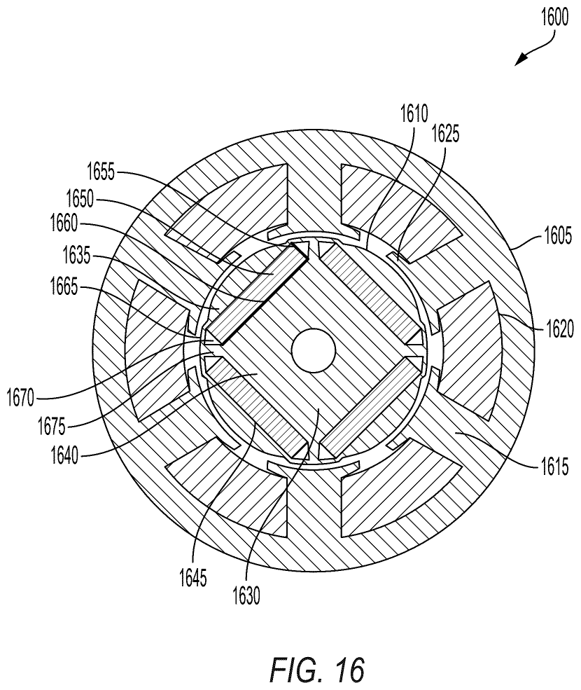

FIG. 16 illustrates a motor 1600 for use in the power tool 100. Unlike the previously described motors, the motor 1600 is an inner rotor interior permanent magnet (IPM) motor and does not include a spoke-type configuration. The motor 1600 includes a stator 1605 and a rotor 1610. The stator includes a plurality of stator teeth 1615 and a plurality of stator winding slots 1620 which are configured to receive a plurality of windings. Each of the plurality of stator teeth 1615 includes a protruding portion 1625 configured to aid in retaining the stator windings. In the example illustrated, the stator 1605 is illustrated as including a segmented stator. The segmented stator is constructed from multiple segments instead of being a single, continuous piece. Each segment of the stator 1605 is made of, for example, a laminated sheet and carries a portion of the stator winding slots 1620. During the manufacturing process, the segments are mechanically and electrically connected to form the stator 1605. Although the example illustrated includes a segmented stator, it should be understood that in some embodiments, the motor 1600 may not include a segmented stator.

The rotor 1610 includes a plurality of slots, and each slot includes a magnet housing portion 1645 configured to receive a magnet 1650. The magnet 1750 may be composed of similar materials as previously described, and/or secured to the magnet housing portion 1645, as previously described. The magnet 1650 includes a length 1655 and a width 1660. The rotor additionally includes an inner rotor portion 1630 and a plurality of outer rotor portions 1635. Each one of the plurality of outer rotor portions 1635 are configured to connect to another one of the plurality of outer rotor portions 1635 via an outer rib 1665. Additionally, the outer rib 1665 is configured to connect to the inner rotor portion 1630 via a connecting portion 1675. In some instances, the outer rib 1665 and the connecting portion 1675 form a gap 1670, the gap 1670 positioned adjacent to the magnet housing portion 1645. In some instances, the outer rib 1665 and connecting portion 1675 are configured to aid in retaining the magnet 1650 within the magnet housing portion 1645. In some examples, the motor 1600 has an outer diameter of 40 millimeters to 60 millimeters and has an axial length 24 millimeters.

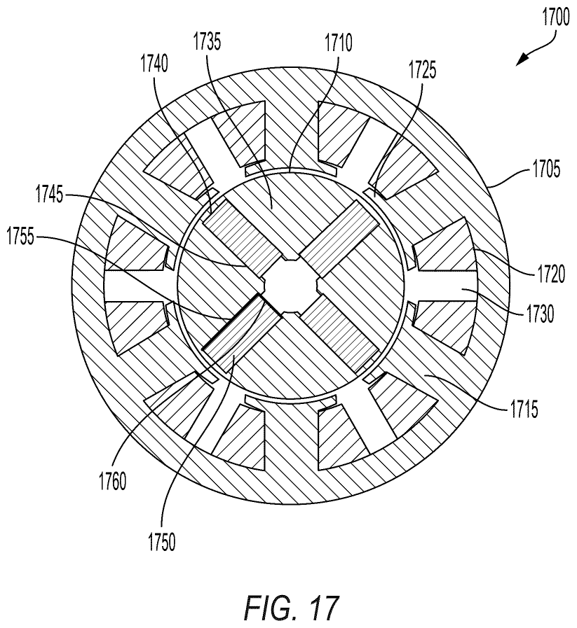

FIG. 17 illustrates a motor 1700 for use in the power tool 100. The motor 1700 includes a spoke-type magnet configuration. The motor 1700 is illustrated as a 6 slot, 4 pole (6s4p) motor, but may be configured to include more or fewer slots and/or poles, or any number of slots and poles. For instance, in other embodiments, the motor 1700 may be a 9 slot, 8 pole (9s8p) motor. The motor 1700 includes a stator 1705 and a rotor 1710. The stator includes a plurality of stator teeth 1715 and a plurality of stator winding slots 1720 which are configured to receive a plurality of windings. Each of the plurality of stator teeth 1715 includes a protruding portion 1725 configured to aid in retaining the stator windings.

The motor 1700 also includes a needle gap 1730, also referred to as a slot gap. The needle gap 1730 may be defined by the space between adjacent windings received by the plurality of stator winding slots 1720. In some instances, the needle gap 1730 is configured to provide electrical insulation and prevent short circuits between the windings. Additionally, the needle gap 1730 can reduce eddy currents in the stator 1705, further enhancing the efficiency of the motor 1700. Furthermore, the needle gap 1730 can allow for a higher slot fill factor, which is the ratio of the windings to the total cross-sectional area of the plurality of stator winding slots 1720. In some instances, a higher slot fill factor leads to improved motor efficiency. In some instances, the motor 1700 has an outer diameter of between 43 millimeters and 55 millimeters. In some instances, the motor 1700 has an axial length 24 millimeters. In some embodiments, the motor 1700 includes a segmented stator 1705. In other embodiments, the motor 1700 does not include a segmented stator.

The rotor 1710 includes a plurality of slots configured in a spoke-type configuration, and each slot includes a magnet housing portion 1745 configured to receive a magnet 1750. The magnet 1750 may be composed of similar materials as previously described, and/or secured to the magnet housing portion 1745 as previously described. The magnet 1750 includes a length 1755 and a width 1760. The rotor 1710 additionally includes a plurality of inner portions 1735 and an outer rib 1740 positioned between each of the inner portions 1735. The outer rib 1740 is configured to retain the magnet 1750 within the magnet housing portion 1745. In some examples, the length 1755 of the magnet 1750 must be larger than half of a width of one of the plurality of stator teeth 1815. In some examples, the width 1760 of the magnet 1750 may be determined by EQN. 1, as described above.

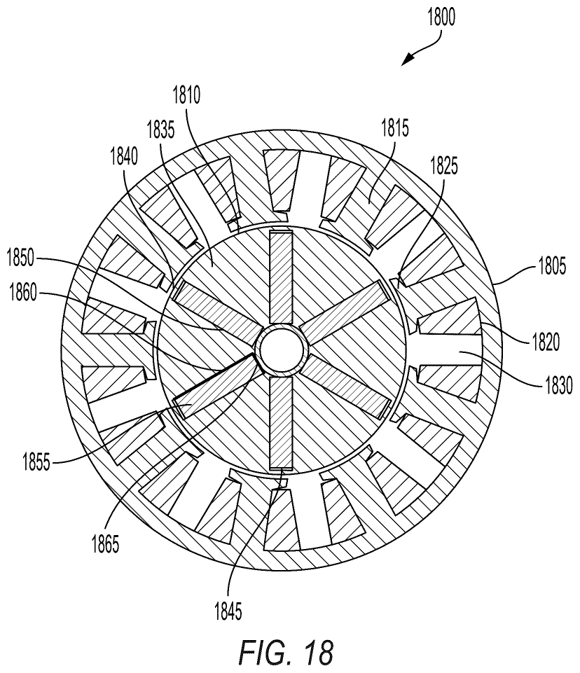

FIG. 18 illustrates a motor 1800 for use in the power tool 100. The motor 1800 includes a spoke-type magnet configuration. The motor 1800 is illustrated as a 9 slot, 6 pole (9s6p) motor, but may be configured to include more or fewer slots and/or poles. The motor 1800 includes a stator 1805 and a rotor 1810. The stator includes a plurality of stator teeth 1815 and a plurality of stator winding slots 1820 which are configured to receive a plurality of windings. Each of the plurality of stator teeth 1815 include a protruding portion 1825 configured to aid in retaining the stator windings. The motor 1800 also includes a needle gap 1830, similar to previously described needle gaps. The needle gap 1830 is the space between adjacent windings received by the stator slots 1820. In some instances, the motor 1800 has an outer diameter of between 43 millimeters and 55 millimeters. In some instances, the motor 1800 has an axial length of 24 millimeters. In some embodiments, the motor 1800 includes a segmented stator 1805. In other embodiments, the motor 1800 does not include a segmented stator.

The rotor 1810 includes a plurality of slots configured in a spoke-type configuration, and each slot includes a magnet housing portion 1850 configured to receive a magnet 1855. The magnet 1855 may be composed of similar materials as previously described, and/or secured to the magnet housing portion 1850 as previously described. The magnet 1855 includes a length 1860 and a width 1865. The rotor additionally includes a plurality of inner portions 1835 and an outer rib 1840 positioned between each of the inner portions 1835. The outer rib 1840 is configured to retain the magnet 1855 within the magnet housing portion 1850. In the illustrated embodiment, the rotor 1810 further includes a gap 1845 between the outer rib 1840 and the magnet 1855. In some embodiments, there is no gap between the outer rib 1840 and the magnet 1855. In some examples, the length 1860 of the magnet 1855 must be larger than half of a width 1865 of one of the plurality of stator teeth 1815. In some examples, the width 1865 of the magnet 1855 may be determined by EQN. 1, as described above.

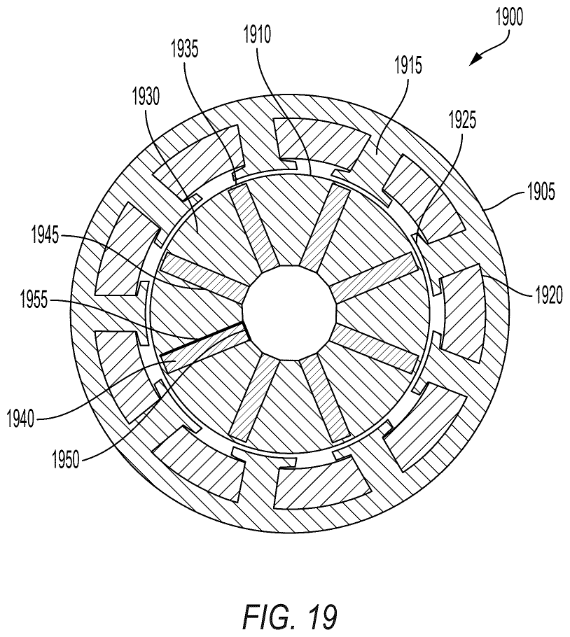

FIG. 19 illustrates a motor 1900 for use in the power tool 100. The motor 1900 includes a spoke-type magnet configuration. The motor 1900 is illustrated as a 9 slot, 8 pole (9s8p) motor, but may be configured to include more or fewer slots and/or poles. The motor 1900 includes a stator 1905 and a rotor 1910. The stator includes a plurality of stator teeth 1915 and a plurality of stator winding slots 1920 which are configured to receive a plurality of windings. Each of the plurality of stator teeth 1915 includes a protruding portion 1925 configured to aid in retaining the stator windings. In the example illustrated, the stator 1905 is illustrated as including a segmented stator and may include similar features as those previously described. Although the motor 1900 includes a segmented stator, in some embodiments, the motor 1900 may not be segmented. In some instances, the motor 1900 has an outer diameter of between 43 millimeters and 55 millimeters. In some instances, the motor 1900 has an axial length 24 millimeters.

The rotor 1910 includes a plurality of slots configured in a spoke-type configuration, and each slot includes a magnet housing portion 1945 configured to receive a magnet 1940. The magnet 1940 may be composed of similar materials as previously described, and/or secured to the magnet housing portion 1745 as previously described. The magnet 1940 includes a length 1955 and a width 1960. The rotor additionally includes a plurality of inner portions 1930 and an outer rib 1935 positioned between each of the inner portions 1930. The outer rib 1935 is configured to retain the magnet 1940 within the magnet housing portion 1945. In some examples, the length 1655 of the magnet 1940 must be larger than half of a width of one of the plurality of stator teeth. In some examples, the width 1960 of the magnet 1940 may be determined by EQN. 1, as described above.

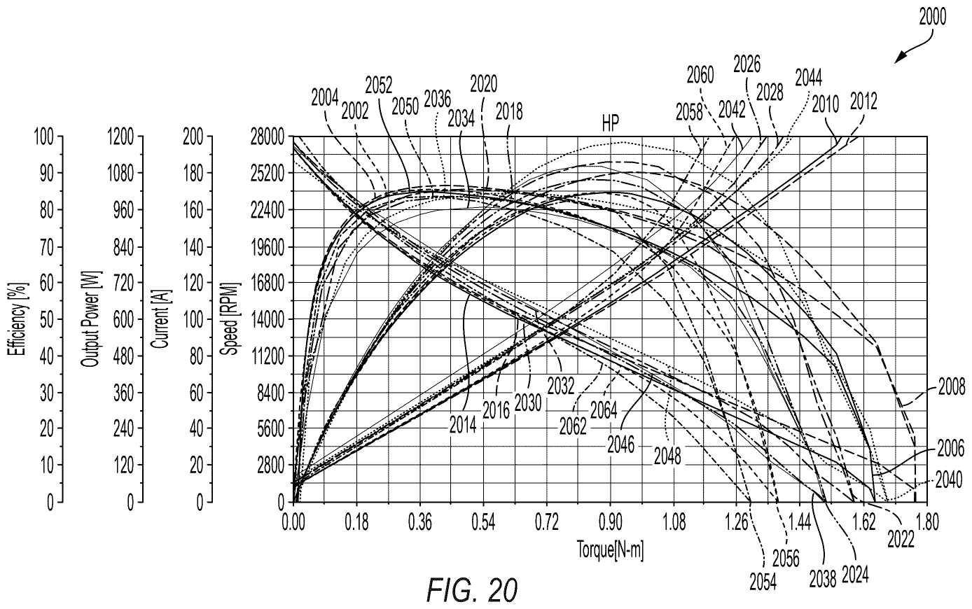

FIG. 20 is a graphical illustration of the performance of some of the motors described herein. The illustration includes a graph 2000 including an X-axis of torque in Newton-meters (N-m) and a Y-axis that includes efficiency (measured in percentage), output power (measured in Watts), motor current (measured in Amperes), and motor speed (measured in revolutions per minute [RPM]). The graph 2000 includes a benchmark IMP efficiency 2002 and a segmented IPM efficiency 2004, such as for the motor 1600. As previously described, many of the motors 1700, 1800, 1900 may include multiple slot and pole configurations, such as 6 slot, 4 pole (6s4p), 9 slot, 6 pole (9s6p), or 9 slot, 8 pole (9s8p). The graph 2000 includes a spoke 6s4p efficiency 2018, and a segmented spoke 6s4p efficiency 2020. The graph 2000 further includes a spoke 9s6p efficiency 2034 and a segmented spoke 9s6p efficiency 2036. The graph 2000 further includes a spoke 9s8p efficiency 2050 and a segmented spoke 9s8p efficiency 2052. As illustrated in the graph 2000, in some instances the lower slot/pole motors, such as motor 1600, may have higher efficiency at lighter loads, or at lower torque values. In some instances, the higher slot/pole motors may have a lower efficiency at lighter loads. In some examples, the segmented spoke stall torque is approximately the same as the benchmark IPM motor.

The graph 2000 further includes a benchmark IMP output power 2006 and a segmented IPM efficiency 2008, such as for the motor 1600. The graph 2000 includes a spoke 6s4p output power 2022, and a segmented spoke 6s4p output power 2024. The graph 2000 further includes a spoke 9s6p output power 2038 and a segmented spoke 9s6p output power 2040. The graph 2000 further includes a spoke 9s8p output power 2054 and a segmented spoke 9s8p output power 2056. As illustrated by the spoke 9s6p output power 2038 and the segmented spoke 9s6p output power 2040, the higher pole motor designs, such as motor 1800, have a higher peak power value. For example, the segmented spoke 9s6p output power 2040 includes a peak output power value of approximately 1200 Watts at 0.90 N-m. In some embodiments, the spoke motors have approximately 10-20% higher peak output power when compared to the benchmark IPM motor.

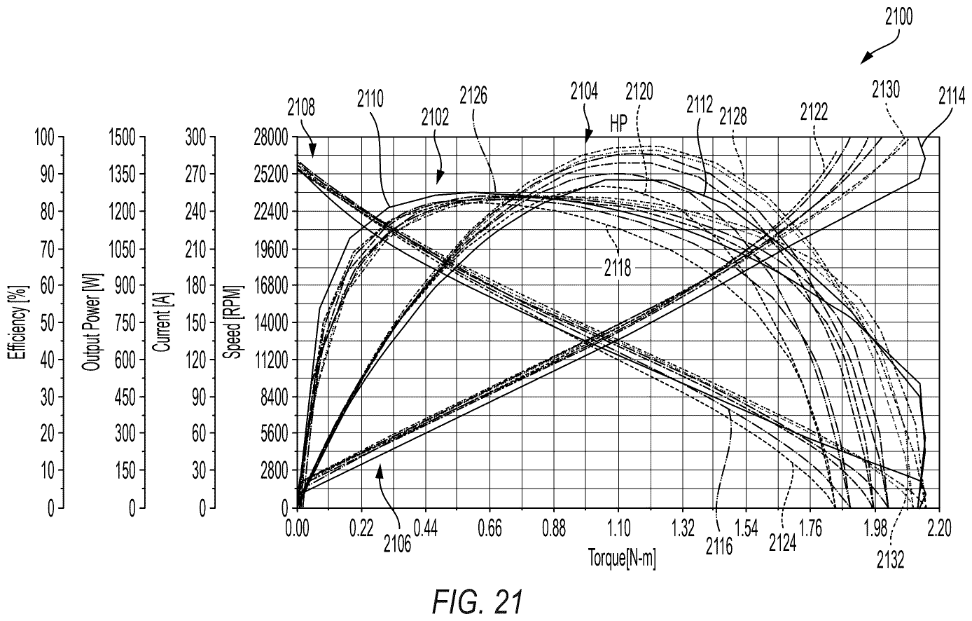

The graph 2000 further includes a benchmark IMP current 2010 and a segmented IPM current 2012, such as for the motor 1600. The graph 2000 includes a spoke 6s4p current 2026, and a segmented spoke 6s4p current 2028. The graph 2000 further includes a spoke 9s6p current 2042 and a segmented spoke 9s6p current 2044. The graph 2000 further includes a spoke 9s8p current 2058 and a segmented spoke 9s8p current 2060. The graph 2000 further includes a benchmark IMP RPM 2014 and a segmented IPM RPM 2016, such as described regarding the motor 1600. The graph 2000 includes a spoke 6s4p RPM 2030, and a segmented spoke 6s4p RPM 2032. The graph 2000 further includes a spoke 9s6p RPM 2046 and a segmented spoke 9s6p RPM 2048. The graph 2000 further includes a spoke 9s8p RPM 2062 and a segmented spoke 9s8p RPM 2064. Specific comparisons of traditional IPM motors contrasted with spoke configuration motors are illustrated in FIGS. 21-23 and described below.

FIG. 21 is a graphical illustration of the performance of some of the segmented spoke motors described herein when compared with an IPM motor. The illustration includes a graph 2100 including an X-axis of torque in Newton-meters (N-m) and a Y-axis that includes efficiency, output power, motor current, and motor speed, similar to graph 2000 as previously described. The graph 2100 includes efficiency 2102, output power 2204, current 2106, and speed 2108 of several motor configurations. As previously described, the motors 1700, 1800, and 1900 may include an outer diameter that ranges from 43 mm to 55 mm. In the example illustrated in FIG. 21, the IPM motor includes an outer diameter of 60 mm. In some examples, the graph 2100 includes an IPM motor efficiency 2110, a 43 mm segmented spoke motor efficiency 2118, and a 55 mm segmented spoke motor efficiency 2126. The graph 2100 includes an IPM motor output power 2112, a 43 mm segmented spoke motor output power 2120, and a 55 mm segmented spoke motor output power 2128. The graph 2100 includes an IPM motor current 2114, a 43 mm segmented spoke motor current 2122, and a 55 mm segmented spoke motor current 2130. The graph 2100 includes an IPM motor speed 2116, a 43 mm segmented spoke motor current 2124, and a 55 mm segmented spoke motor current 2132. Below in Table 1 is a comparison of the motors represented in the graph 2100, including a comparison of the motor outer diameter, the peak output power, and the size of the motors.

TABLE 1

| | Outer | Peak | Size |
|---|---|---|---|
| Motor | Diameter | Output Power | (volume) |
| 60 mm IPM Motor | 60 millimeters | 1330 Watts | 68 cm³ |
| 55 mm Segmented Spoke Motor | 55 millimeters | 1480 Watts | 55 cm³ |
| 43 mm Segmented Spoke Motor | 43 millimeters | 1310 Watts | 34 cm³ |

As illustrated in the graph 2100 and demonstrated in Table 1, the 43 mm segmented spoke motor has approximately the same peak output power as the IPM motor with a reduced outer diameter size of approximately 50%. Additionally, the 55 mm segmented spoke motor has approximately a 13% increase in output power with a reduced outer diameter size of approximately 25%. As demonstrated by graph 2100 and Table 1, the 43 mm segmented spoke motor offers a significant size reduction with a similar power output when compared with the IPM motor, and the 55 mm segmented spoke motor offers a significant output power increase with a notable size reduction with a similar power output when compared with the IPM motor.

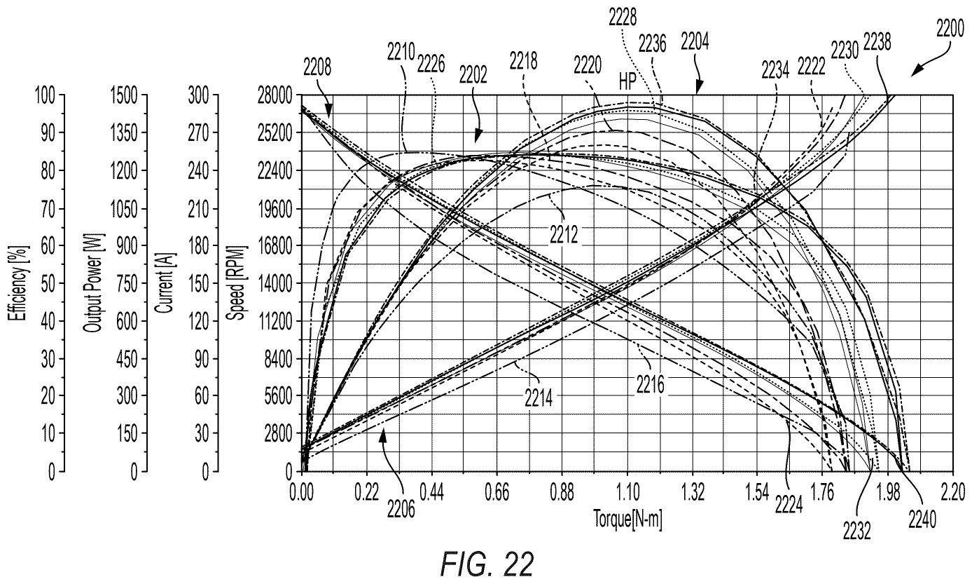

FIG. 22 is a graphical illustration of the performance of some of the segmented spoke motors described herein when compared with an IPM motor. The illustration includes a graph 2200 including an X-axis of torque in Newton-meters (N-m) and a Y-axis that includes efficiency, output power, motor current, and motor speed, similar to graphs 2000, 2100 as previously described. The graph 2200 includes efficiency 2202, output power 2204, current 2206, and speed 2208 of several motor configurations. As previously described, the motors 1700, 1800, and 1900 may include an outer diameter that ranges from 43 mm to 55 mm. In the example illustrated in FIG. 22, the IPM motor includes an outer diameter of 50 mm. In some examples, the graph 2200 includes a IPM motor efficiency 2210, a 43 mm segmented spoke motor efficiency 2218, a 50 mm segmented spoke motor efficiency 2226, and a 55 mm segmented spoke motor efficiency 2234. The graph 2200 includes an IPM motor output power 2212, a 43 mm segmented spoke motor output power 2220, a 50 mm segmented spoke motor output power 2228, and a 55 mm segmented spoke motor output power 2236. The graph 2200 includes an IPM motor current 2214, a 43 mm segmented spoke motor current 2222, a 50 mm segmented spoke motor current 2230, and a 55 mm segmented spoke motor current 2238. The graph 2200 includes an IPM motor speed 2216, a 43 mm segmented spoke motor speed 2224, a 50 mm segmented spoke motor speed 2232, and a 55 mm segmented spoke motor speed 2240. Below in Table 2 is a comparison of the motors represented in the graph 2200, including a comparison of the motor outer diameter, the peak output power, and the size of the motors.

TABLE 2

| | Outer | Peak | Size |
|---|---|---|---|
| Motor | Diameter | Output Power | (volume) |
| 50 mm IPM Motor | 50 millimeters | 1137 Watts | 48 cm³ |
| 55 mm Segmented Spoke Motor | 55 millimeters | 1480 Watts | 55 cm³ |
| 50 mm Segmented Spoke Motor | 50 millimeters | 1445 Watts | 48 cm³ |
| 43 mm Segmented Spoke Motor | 43 millimeters | 1310 Watts | 34 cm³ |

As illustrated in the graph 2200 and demonstrated in Table 2, the 43 mm segmented spoke motor has an increased power of approximately 16% when compared with the IPM motor while having a reduced outer diameter size by approximately 26%. The 50 mm segmented spoke motor has approximately a 28% increase in output power when compared with the IPM motor while having approximately the same outer diameter size. The 55 mm segmented spoke motor has approximately a 33% increase in output power with an increased outer diameter size of approximately 21%. As demonstrated by graph 2200 and Table 2, the 43 mm segmented spoke motor offers a significant size reduction with a similar power output when compared with the IPM motor, and the 50 mm segmented spoke motor offers a significant output power increase with a similar outer diameter when compared with the IPM motor. The 55 mm segmented spoke motor includes an even greater output power increase when compared with both the 50 mm segmented spoke motor and the IPM motor.

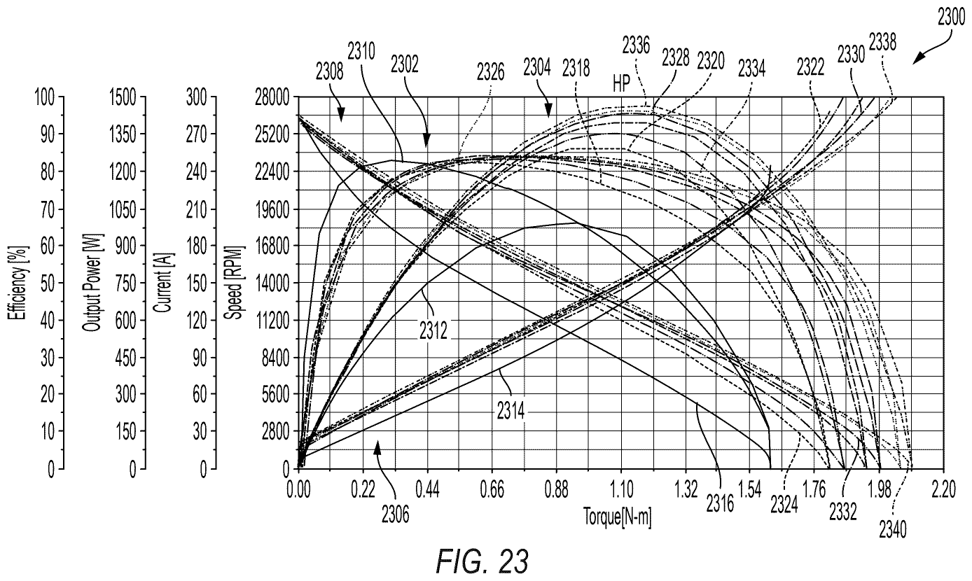

FIG. 23 is a graphical illustration of the performance of some of the segmented spoke motors described herein when compared with an IPM motor. The illustration includes a graph 2300 including an X-axis of torque in Newton-meters (N-m) and a Y-axis that includes efficiency, output power, motor current, and motor speed, similar to graphs 2000, 2100, 2200 as previously described. The graph 2300 includes efficiency 2302, output power 2304, current 2306, and speed 2308 of several motor configurations. As previously described, the motors 1700, 1800, and 1900 may include an outer diameter that ranges from 43 mm to 55 mm. In the example illustrated in FIG. 23, the IPM motor includes an outer diameter of 45 mm. In some examples, the graph 2300 includes an IPM motor efficiency 2310, a 43 mm segmented spoke motor efficiency 2318, a 45 mm segmented spoke motor efficiency 2326, and a 50 mm segmented spoke motor efficiency 2334. The graph 2300 includes an IPM motor output power 2312, a 43 mm segmented spoke motor output power 2320, a 45 mm segmented spoke motor output power 2328, and a 50 mm segmented spoke motor output power 2336. The graph 2300 includes an IPM motor current 2314, a 43 mm segmented spoke motor current 2322, a 45 mm segmented spoke motor current 2330, and a 50 mm segmented spoke motor current 2338. The graph 2300 includes an IPM motor speed 2316, a 43 mm segmented spoke motor speed 2324, a 45 mm segmented spoke motor speed 2332, and a 50 mm segmented spoke motor speed 2340. Below in Table 2 is a comparison of the motors represented in the graph 2300, including a comparison of the motor outer diameter, the peak output power, and the size of the motors.

TABLE 3

| | Outer | Peak | Size |
|---|---|---|---|
| Motor | Diameter | Output Power | (volume) |
| 45mm IPM Motor | 45 millimeters | 1000 Watts | 38 cm³ |
| 50mm Segmented Spoke Motor | 50 millimeters | 1445 Watts | 88 cm³ |
| 45 Segmented Spoke Motor | 45 millimeters | 1370 Watts | 38 cm³ |
| 43mm Segmented Spoke Motor | 43 millimeters | 1310 Watts | 34 cm³ |

As illustrated in the graph 2300 and demonstrated in Table 3, the 43 mm segmented spoke motor has an increased power of approximately 31% when compared with the IPM motor while having a reduced outer diameter size by approximately 9%. The 45 mm segmented spoke motor has approximately a 38% increase in output power when compared with the IPM motor while having approximately the same outer diameter size. The 50 mm segmented spoke motor has approximately a 46% increase in output power with an increased outer diameter size of approximately 23%. As demonstrated by graph 2300 and Table 3, the 43 mm segmented spoke motor offers a notable size reduction with a significant power output when compared with the IPM motor, and the 45 mm segmented spoke motor offers a significant output power increase with a similar outer diameter when compared with the IPM motor. The 50 mm segmented spoke motor includes an even greater output power increase when compared with the IPM motor.

Thus, embodiments described herein provide a power tool including a spoke-type motor. Various features and advantages are set forth in the following claims.

What is claimed is:

1. A power tool comprising:
a battery pack interface configured to receive a removable and rechargeable battery pack; and
a motor including:
a stator including a plurality of stator teeth configured to receive a plurality of stator coils, and
a rotor including:
a plurality of slots configured in a spoke-type configuration, each of the plurality of slots including a magnet housing portion configured to receive a magnet,
wherein the magnet includes a length and a width, the length of the magnet being larger than half of a width of one of the plurality of stator teeth.

2. The power tool of claim 1, wherein the motor has an outer diameter of between 43 millimeters and 55 millimeters.

3. The power tool of claim 1, wherein the stator is a segmented stator.

4. The power tool of claim 1, wherein the motor is a 9 slot, 6 pole motor.

5. The power tool of claim 1, wherein the motor is a 9 slot, 8 pole motor.

6. The power tool of claim 1, wherein the stator further includes a needle gap defined by a space between two adjacent stator coils of the plurality of stator coils.

7. The power tool of claim 1, wherein the magnet is composed of neodymium iron boron, and wherein the magnet is secured to the magnet housing portion using an adhesive.

8. The power tool of claim 1, wherein the width of the magnet is determined by an equation:
$$Magnet Width = \frac{π ( diameter of rotor - stator tooth width )}{number of poles} .$$

9. The power tool of claim 1, wherein the motor has a higher efficiency at lighter loads when compared to a motor with a higher number of slots and poles.

10. The power tool of claim 1, wherein the motor has a higher peak output power value when compared to a motor with a lower number of slots and poles.

11. The power tool of claim 1, wherein the motor has a peak output power value of approximately 1200 Watts at 0.90 N-m.

12. The power tool of claim 1, wherein the motor has approximately an equal peak output power as an interior permanent magnet motor, and wherein the motor has an outer diameter size of approximately 50% less than the interior permanent magnet motor.

13. The power tool of claim 1, wherein the motor has an output power of approximately 13% greater when compared to an interior permanent magnet motor, and wherein the motor includes an outer diameter size of approximately 25% less than the interior permanent magnet motor.

14. The power tool of claim 1, wherein the motor has approximately a 28% increase in output power when compared to an interior permanent magnet motor, and wherein the motor has approximately an equal outer diameter size as the interior permanent magnet motor.

15. The power tool of claim 1, wherein the motor has approximately a 33% increase in output power when compared to an interior permanent magnet motor, and wherein the motor has an outer diameter size of approximately 21% larger than the interior permanent magnet motor.

16. A motor comprising:
a stator including a plurality of stator teeth configured to receive a plurality of stator coils, and
a rotor including:
a plurality of slots configured in a spoke-type configuration, each of the plurality of slots including a magnet housing portion configured to receive a magnet,
wherein the magnet includes a length and a width, the length of the magnet being larger than half of a width of one of the plurality of stator teeth.

17. The motor of claim 16, wherein stator is a segmented stator.

18. The motor of claim 16, wherein the motor has an outer diameter of between 43 mm and 55 mm, and wherein the motor has an output power of between 13% and 28% greater than an interior permanent magnet motor, the interior permanent magnet motor having an outer diameter of between 45 mm and 60 mm.

19. A power tool comprising:
a battery pack interface configured to receive a removable and rechargeable battery pack; and
a motor having an outer diameter of between 43 mm and 55 mm, the motor including:
a segmented stator including:
a plurality of stator teeth configured to receive a plurality of stator coils, and
a rotor including:
a plurality of slots configured in a spoke-type configuration, each of the plurality of slots including a magnet housing portion configured to receive a magnet,
wherein the magnet includes a length and a width, the length of the magnet being larger than half of a width of one of the plurality of stator teeth.

20. The power tool of claim 19, wherein the motor has an output power of between 13% and 28% greater than an interior permanent magnet motor, the interior permanent magnet motor having an outer diameter of between 45 mm and 60 mm.
